(19) United States
(12) Patent Application Publication
(10) Pub. No.: US 2009/0024560 A1
(43) Pub. Date: Jan. 22, 2009

(54) METHOD AND APPARATUS FOR HAVING ACCESS TO WEB PAGE

(75) Inventors: Hyo KIM, Seoul (KR); Dong-Hyun SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/019,802

(22) Filed: Jan. 25, 2008

(30) Foreign Application Priority Data
Jul. 20, 2007 (KR) 10-2007-0072926

(51) Int. Cl. G06F 17/30

(52) U.S. Cl. 707/1; 707/E17.001

(57) ABSTRACT

Provided are a method and apparatus for accessing a web page. The method includes searching a first web page for links and extracting path information of each link found; generating a link hierarchy composed of nodes, each having the extracted path information; displaying the generated link hierarchy; and receiving a signal, which selects a node in the displayed link hierarchy, accessing a second web page corresponding to path information of the selected node in response to the signal, and displaying the second web page.

This application claims priority from Korean Patent Application No. 10-2007-0072926 filed on Jul. 20, 2007 in the Korean Intellectual Property Office, the disclosure of which is incorporated herein by reference in its entirety.

### BACKGROUND OF THE INVENTION

1. Field of the Invention

The present invention relates to accessing a web page, and more particularly, to enabling a user to easily access a desired web page.

2. Description of the Related Art

The Internet is currently serving as a medium for sharing knowledge, and it is no exaggeration to say that the Internet itself is a major repository of knowledge. Therefore, a user who desires to obtain knowledge can access the Internet at any time and easily obtain the knowledge using a search engine.

However, while searching the Internet, the user may find that desired information is not always clearly presented in a web document and that the web document has a plurality of sub web documents connected by a link.

In addition, in order to access a desired web page or a desired service, the user has to search the Internet for the web page or the service. Not only is this process cumbersome, but also it is difficult to find the web page or the service.

Furthermore, if the web page or the service is not placed on a first screen of a home page, the user has to keep searching the home page for the web page or the service by making a number of inputs. For example, in order to find weather information at web site (for example, “www.naver.com”), the user has to go through five processes of executing a web browser->entering a website address (for example, “www.naver.com”) to an address window->“Naver Home”->“News Home”->“Weather.”

If the user has to repeat these processes whenever necessary, it would be very inefficient. In particular, it is inefficient for the user who needs the weather information to have to load web pages such as “Naver Home” and “News Home.”

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

The present invention provides a method and apparatus for accessing a web page, the method and apparatus enabling a user to easily access a desired web page.

However, aspects of the present invention are not restricted to the one set forth herein. The above and other aspects of the present invention will become more apparent to one of ordinary skill in the art to which the present invention pertains by referencing the detailed description of exemplary embodiments of the present invention given below.

According to an aspect of the present invention, there is provided a method of accessing a web page. The method includes searching a web page for links and extracting path information of each link found; generating a link hierarchy composed of nodes, each having the extracted path information; displaying the generated link hierarchy; and receiving a signal, which selects a node in the displayed link hierarchy, accessing a web page corresponding to path information of the selected node in response to the signal, and displaying the web page.

According to another aspect of the present invention, there is provided an apparatus for accessing a web page. The apparatus includes a link information extraction unit searching a web page for links and extracting path information of each link found; a link hierarchy generation unit generating a link hierarchy composed of nodes, each having the extracted path information; a link hierarchy display unit displaying the generated link hierarchy; and a control unit receiving a signal, which selects a node in the displayed link hierarchy, accessing a web page corresponding to path information of the selected node in response to the signal, and displaying the web page.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for accessing a web page according to an exemplary embodiment of the present invention;

FIG. 2 illustrates an example of a tree structure;

FIG. 3 illustrates an example of a user interface screen for setting a range of links displayed for a user;

FIGS. 4A and 4B and 5 illustrate examples of a link hierarchy actually displayed for a user; and

FIG. 6 is a flowchart illustrating a method of accessing a web page according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and repeated descriptions thereof have been omitted.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, generate means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which comprises one or more executable instructions for implementing the specified logical function(s). It should also be noted that in some alternative implementations, the operations noted in the blocks may occur out of order. For example, two blocks shown in succession may in fact be executed substantially concurrently or the blocks may sometimes be executed in reverse order depending upon the operations involved.

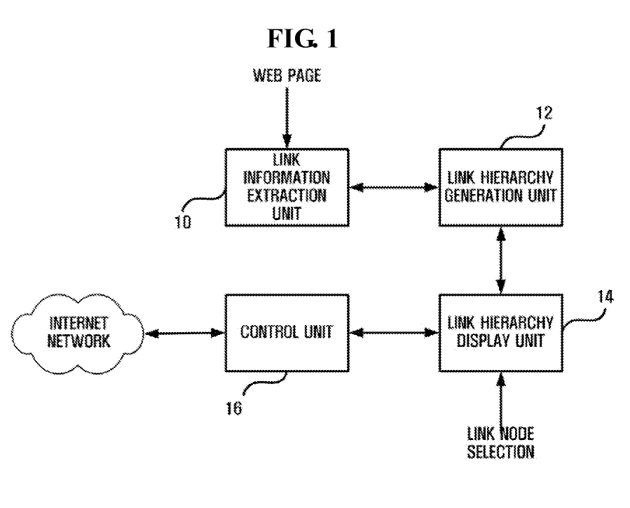

FIG. 1 is a block diagram of an apparatus for accessing a web page according to an exemplary embodiment of the present invention.

Referring to FIG. 1, the apparatus includes a link information extraction unit 10, a link hierarchy generation unit 12, a link hierarchy display unit 14, and a control unit 16.

The link information extraction unit 10 searches a web page for links and extracts uniform resource locator (URL) information of each link found. In this case, URL information of a link denotes an access path to the link, and an access path may contain information regarding a hierarchical relationship between links.

If a user accesses a website using a terminal (such as a personal computer (PC) or a cellular phone) through a wired or wireless Internet network, a web page is displayed on a web browser. Here, the link information extraction unit 10 may extract URL information of each link of the web page displayed when the user accesses the web page. In another example, a text window may be provided to the user. If the user registers a website, from which URL information of each link is to be extracted, in the text window, the link information extraction unit 10 may access the registered website and extract URL information of each link of a web page. However, the present invention is not limited thereto, and various exemplary embodiments of the present invention can be implemented.

The link information extraction unit 10 may recursively extract URL information of each link of a website in order of highest to lowest link.

According to a user's setting, the link information extraction unit 10 may extract URL information of each of one or more links from a web page.

The link information extraction unit 10 may be implemented as software that searches a link list in a web page and extracts URL information of each link found, and the software may be linked to a web browser. Alternatively, the link information extraction unit 10 may be implemented using data files which are provided at a site introducing web pages of a website. Alternatively, the link information extraction unit 10 may extract URL information of each link based on data obtained when accessing a website.

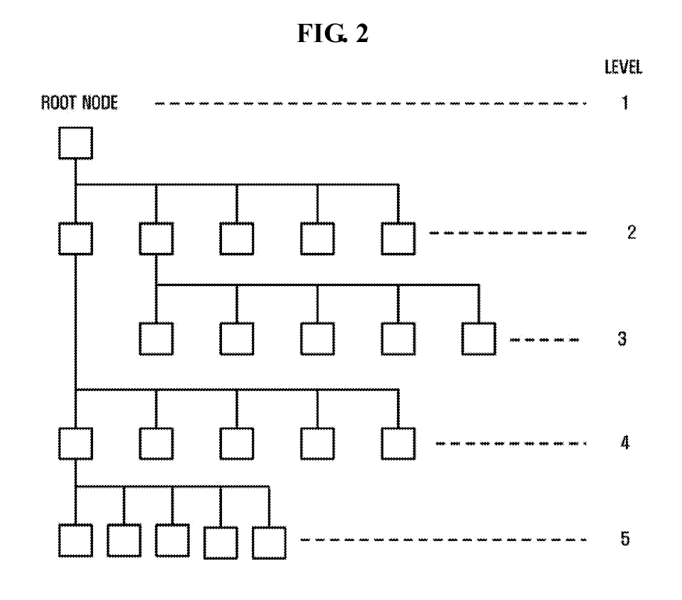

The link hierarchy generation unit 12 generates a link hierarchy based on URL information of each link extracted by the link information extraction unit 10 and stores the generated link hierarchy in a storage unit (not shown). The generated link hierarchy consists of nodes having the URL information of the links as illustrated in FIG. 2 and may have a tree structure that shows the hierarchical relationship between the nodes.

In order to adjust a range of nodes (links) displayed for a user, the width and depth of the tree structure may be set. In the present exemplary embodiment, the width of the tree structure denotes the number of nodes existing at the same level (excluding a level at which a root node exists). If the level at which the root node exists is one, the level of the tree structure is increased by one as the hierarchy goes down the tree structure from the root node to child nodes. In this case, the depth of the tree structure denotes a maximum level thereof. For example, it can be understood that a tree structure illustrated in FIG. 2 has a width of 5 and a depth of 5. The width and depth of the tree structure may vary according to the number of links found in a web page and the relationship between the links.

The link hierarchy generation unit 12 may analyze the width and depth of a tree structure based on all links of a web page and generate a tree. However, a user may arbitrarily adjust a range of links (the number of nodes), and the link hierarchy generation unit 12 may generate a tree based on the range of links set by the user.

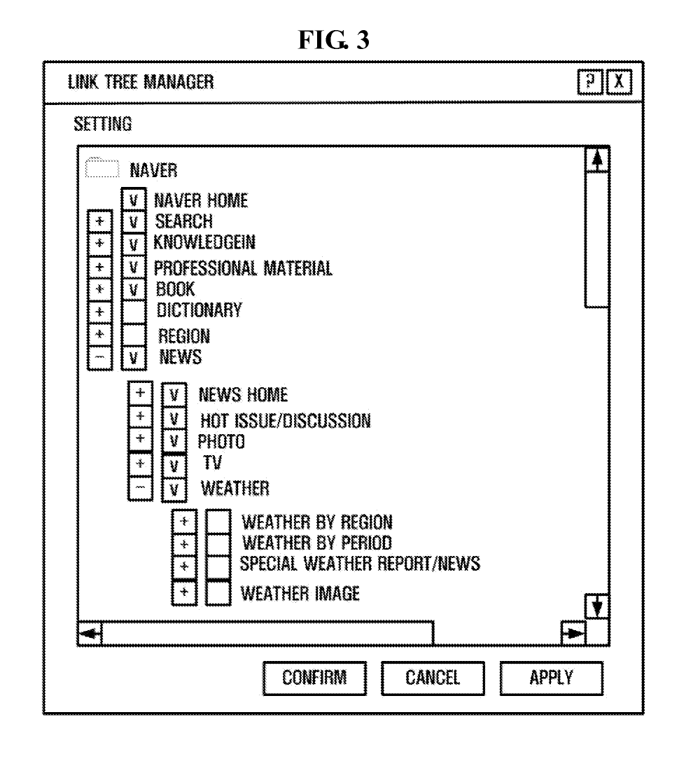

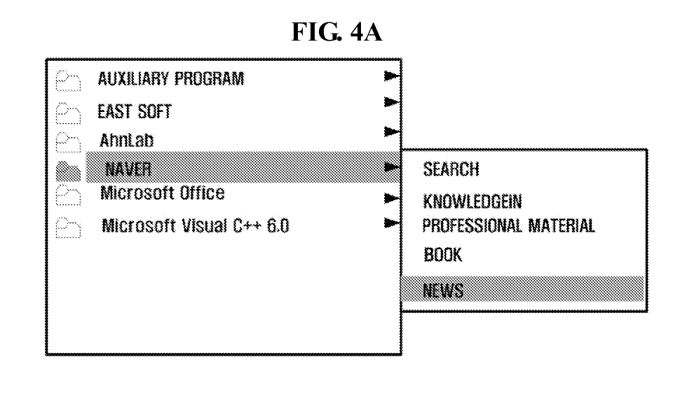

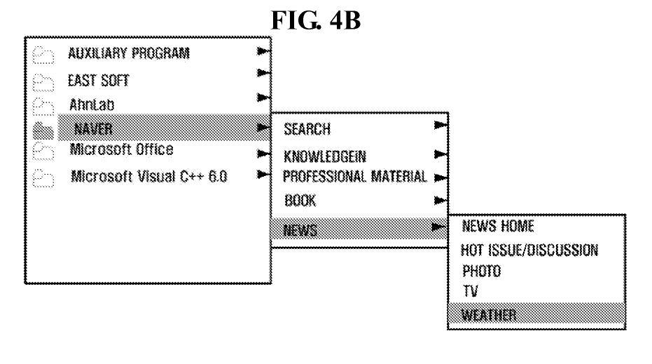

FIG. 3 illustrates an example of a user interface screen for setting a range of links displayed for a user. The width and depth of a tree structure of the user interface screen is set to 5 and 3, respectively. Referring to FIG. 3, “Naver Home” is a root node, and child nodes of the root node, i.e., “Search,” “KnowledgeiN,” “Professional Material,” “Book,” and “News,” have been selected (marked by “v”). In addition, “News Home,” “Hot Issue/Discussion,” “Photo,” “TV,” and “Weather,” which are child nodes of “News,” have been selected (marked by “v”). These selected links are displayed for a user (see FIG. 4B). Through the user interface screen, the range of links can be expanded or reduced, and links can be added, removed, or moved.

In order to generate this tree structure, the link hierarchy generation unit 12 may be implemented as software or a hypertext markup language (HTML) document object model (DOM) parser that generates a tree structure. However, the present invention is not limited thereto.

If the same tree is found in an upper or lower link, there is a danger of falling into an infinite loop. Hence, the link hierarchy generation unit 12 may remove redundant trees and generate an optimized tree. In order to remove the redundant trees, an upper or lower tree may be eliminated according to a user's setting.

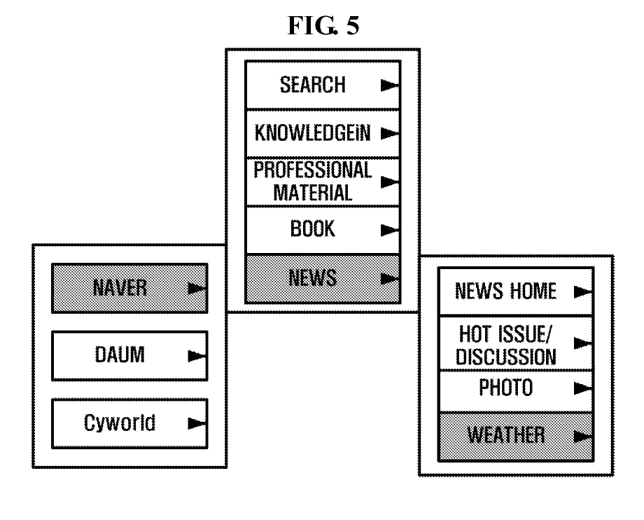

The link hierarchy display unit 14 displays a link hierarchy generated and stored by the link hierarchy generation unit 12 for the user. The link hierarchy display unit 14 may display the link hierarchy in a graphical user interface (GUI) form having a tree structure, an application form registered with the “Start” button of Windows as illustrated in FIGS. 4A and 4B, or a widget form for direct access as illustrated in FIG. 5. In addition, if a link has child links, the link hierarchy may be displayed to be expandable. However, the present invention is not limited thereto, and the link hierarchy may be displayed in various forms. Therefore, the user may go directly to a web page without executing a web browser.

When the user selects a node in the displayed link hierarchy, the control unit 16 accesses a web page corresponding to URL information of the selected node and displays the web page for the user. For example, referring to FIGS. 4B and 5, if the user selects “Naver”->“News”->“Weather,” the control unit 16 displays a web page of the link selected by the user (e.g., a weather related web page at “News” of “Naver”).

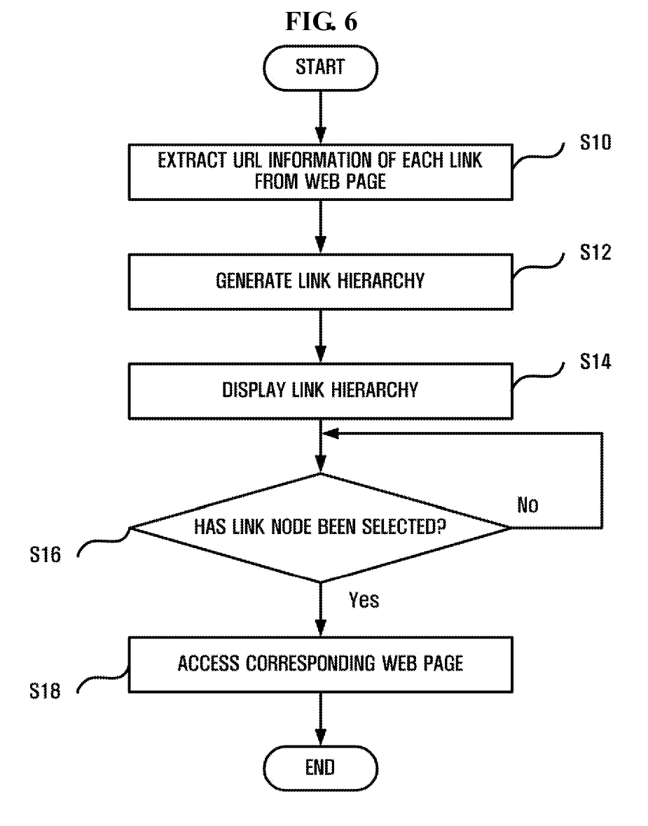

The operation of the apparatus thus configured will now be described with reference to FIG. 6.

Referring to FIG. 6, the link information extraction unit 10 searches a web page for links and extracts URL information of each link found (operation S10).

Then, the link hierarchy generation unit 12 generates a link hierarchy in a tree structure composed of nodes, which have the URL information of the found links, and stores the generated link hierarchy in the storage unit (operation S12). Here, the width and depth of the tree structure may be changed according to a user's setting to generate a tree accordingly.

The link hierarchy display unit 14 displays the stored link hierarchy in any one of the GUI form, the application form registered with the “Start” button of Windows, and the widget form for direct access (operation S14).

Next, if the user selects any one of the nodes in the displayed link hierarchy (operation S16), the control unit 16 accesses a web page corresponding to the URL information of the selected node and displays the web page for the user (operation S18).

Therefore, aspects of the present invention enable a user to easily explore the Web without executing a web browser or searching for a web page.

What is claimed is:

1. A method of accessing web pages, the method comprising:
searching the first web page for links;
extracting path information of each link found;
generating a link hierarchy comprised of nodes, each having the extracted path information;
displaying the generated link hierarchy;
receiving a signal, which selects a node in the displayed link hierarchy;
accessing a second web page corresponding to path information of the selected node in response to the signal; and
displaying the second web page.

2. The method of claim 1, wherein the generating of the link hierarchy comprises generating a tree which indicates a hierarchical relationship between the nodes.

3. The method of claim 2, wherein the generating of the link hierarchy further comprises adjusting a number of nodes according to a setting.

4. The method of claim 3, wherein the adjusting of the number of nodes comprises adjusting at least one of a depth of the tree and a number of nodes existing at a same level of the tree.

5. The method of claim 2, wherein the generating of the tree comprises removing redundant trees if a same tree is found in one of an upper node and a lower node.

6. The method of claim 1, wherein the displaying of the generated link hierarchy comprises displaying the link hierarchy in one of a graphical user interface (GUI) form having a tree structure, an application form registered with a start button of Windows and a widget form.

7. An apparatus for accessing web pages, the apparatus comprising:
a link information extraction unit which searches the first web page for links and extracts path information of each link found;
a link hierarchy generation unit which generates a link hierarchy comprised of nodes, each having the extracted path information;
a link hierarchy display unit which displays the generated link hierarchy; and
a control unit which receives a signal, which selects a node in the displayed link hierarchy, accesses a second web page corresponding to path information of the selected node in response to the signal and displays the second web page.

8. The apparatus of claim 7, wherein the link hierarchy comprises a tree indicating a hierarchical relationship between the nodes.

9. The apparatus of claim 8, wherein the link hierarchy generation unit adjusts a number of nodes according to a setting.

10. The apparatus of claim 9, wherein the link hierarchy generation unit adjusts at least one of a depth of the tree and the number of nodes existing at a same level of the tree.

11. The apparatus of claim 8, wherein the link hierarchy generation unit removes redundant trees if a same tree is found in one of an upper node and a lower node.

12. The apparatus of claim 7, wherein the link hierarchy display unit displays the link hierarchy in one of a graphical user interface (GUI) form having a tree structure, an application form registered with a start button of Windows and a widget form.
